(19) United States
(12) Patent Application Publication
(10) Pub. No.: US 2019/0063047 A1
(43) Pub. Date: Feb. 28, 2019

(54) WATER PIPE STRUCTURE OF BASIN FAUCET

(71) Applicant: YOUSHI (XIAMEN) SANITARY WARE INDUSTRIAL CO., LTD., Xiamen City (CN)

(72) Inventor: Zhangsen You, Xiamen City (CN)

(21) Appl. No.: 15/684,915

(22) Filed: Aug. 23, 2017

(51) Int. Cl. E03C 1/04; F16L 39/00; F16L 9/19

(52) U.S. Cl. CPC E03C 1/0404; F16L 9/19; F16L 39/005

(57) ABSTRACT

A water pipe structure of a basin faucet includes an outer decorative pipe and a soft pipe made mounted in the outer decorative pipe. One end of the soft pipe is fixed to a water outlet connector. Another end of the soft pipe is fixed to a water inlet connector. An outer circumference of the water outlet connector is fixed to the outer decorative pipe. One end of the water inlet connector is fixed to the soft pipe. Another end of the water inlet connector extends out of the outer decorative pipe and is sealedly connected with a water inlet pipe. One end of the outer decorative pipe, connected with the water inlet connector, is provided with a base. An outer wall of the water inlet connector is tightly mated with the base. The water inlet connector and the water outlet connector are connected with the soft pipe stably.

### BACKGROUND OF THE INVENTION

### 1. Field of the Invention

The present invention relates to a faucet, and more particularly to a water pipe structure of a basin faucet.

### 2. Description of the Prior Art

These days, there are a variety of faucets made of different materials, such as copper, aluminum alloy, zinc alloy, and the like. When in use, the water passage of the faucet made of a metal material may contain heavy metal elements, such as lead and cadmium, which flow along with the water. The water passage of the faucet is prone to oxidize corrosion to cause secondary pollution of water to endanger human health.

In order to avoid secondary pollution of the faucet, a conventional curved faucet comprises an outer decorative pipe made of a metal material and a soft pipe mounted in the outer decorative pipe. The water flows out from the soft pipe to avoid the water from getting contact with the metal to cause pollution. However, the water is still in contact with the metal portion at the junction of the outer decorative pipe and the soft pipe. Long-term use will still cause pollution. The connecting structure of the conventional outer decorative pipe and the soft pipe is complex. If the junction of the soft pipe and a water inlet pipe is not handled well, it is easy to cause water leakage. This easily leads to secondary pollution of water.

Accordingly, the inventor of the present invention has devoted himself based on his many years of practical experiences to solve these problems.

### SUMMARY OF THE INVENTION

The primary object of the present invention is to provide a water pipe structure of a basin faucet which is safe and environment-friendly without secondary pollution and has a stable connection configuration.

In order to achieve the aforesaid object, the water pipe structure of the basin faucet of the present invention comprises an outer decorative pipe made of a metal material and a soft pipe made of a plastic material. The soft pipe is mounted in the outer decorative pipe. One end of the soft pipe is fixed to a water outlet connector. Another end of the soft pipe is fixed to a water inlet connector. An outer circumference of the water outlet connector is fixed to the outer decorative pipe. One end of the water inlet connector is fixed to the soft pipe. Another end of the water inlet connector extends out of the outer decorative pipe and is sealedly connected with a water inlet pipe. One end of the outer decorative pipe, connected with the water inlet connector, is provided with a base. An outer wall of the water inlet connector is tightly mated with the base.

Preferably, the water outlet connector includes a fixing sleeve and a metal retaining ring. The fixing sleeve is fixedly disposed at a water outlet end of the soft pipe. An outer wall of the fixing sleeve is mated with an inner wall of the metal retaining ring. An outer wall of the metal retaining ring is fixed to a water outlet end of the outer decorative pipe.

Preferably, the metal retaining ring is connected to the outer decorative pipe by welding, screwing or snap-in.

Preferably, the base is fixed to an inner wall of a water inlet end of the outer decorative pipe. The base has a through hole and at least one mounting hole. The water inlet connector has a neck mated with the through hole so that the water inlet connector is connected to the through hole.

Preferably, the through hole includes a large hole and a small hole. The large hole is communicated with the small hole. The junction of the large hole and the small hole is formed with a reduced opening less than the small hole. The large hole has a diameter equal to or greater than an outer diameter of the water inlet connector. The small hole has a diameter equal to that of the neck of the water inlet connector.

Preferably, one end of the water inlet connector, opposite to the soft pipe, is formed with at least one annular groove. The annular groove is provided with a sealing ring.

Preferably, the outer decorative pipe is a curved pipe, and the curved pipe has a uniform wall thickness.

The water pipe structure of the basin faucet of the present invention adopts the outer decorative pipe made of a metal material and the soft pipe made of a plastic material and mounted in the outer decorative pipe. Under the premise of not affecting the quality of the basin, the water flows in the soft pipe, not in contact with the outer decorative pipe, and will not cause secondary pollution. The basin faucet provides non-toxic, harmless and green environment-friendly effects. In addition, the water inlet connector and the water outlet connector of the present invention are directly fixed to soft pipe, so that the connection is stable. The water inlet connector extends out of the outer decorative pipe so as to be connected to the water inlet pipe conveniently.

### BRIEF DESCRIPTION OF THE DRAWINGS

FIG. 1 is an exploded view of the present invention;

FIG. 1A is an enlarged view of the base of the present invention;

FIG. 2 is a perspective view of the present invention; and

FIG. 3 is a sectional view of the present invention.

### DETAILED DESCRIPTION OF THE PREFERRED EMBODIMENTS

Embodiments of the present invention will now be described, by way of example only, with reference to the accompanying drawings.

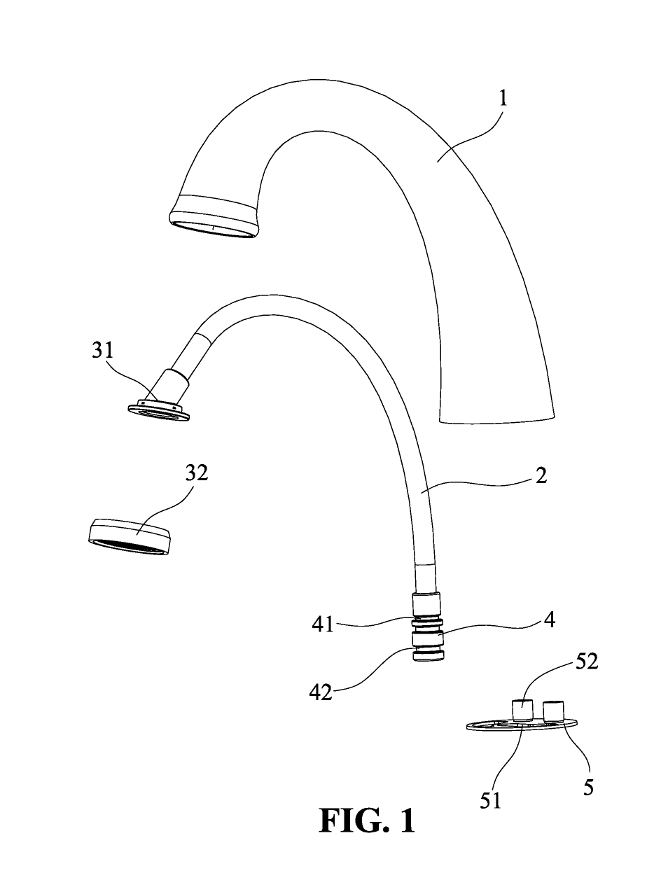

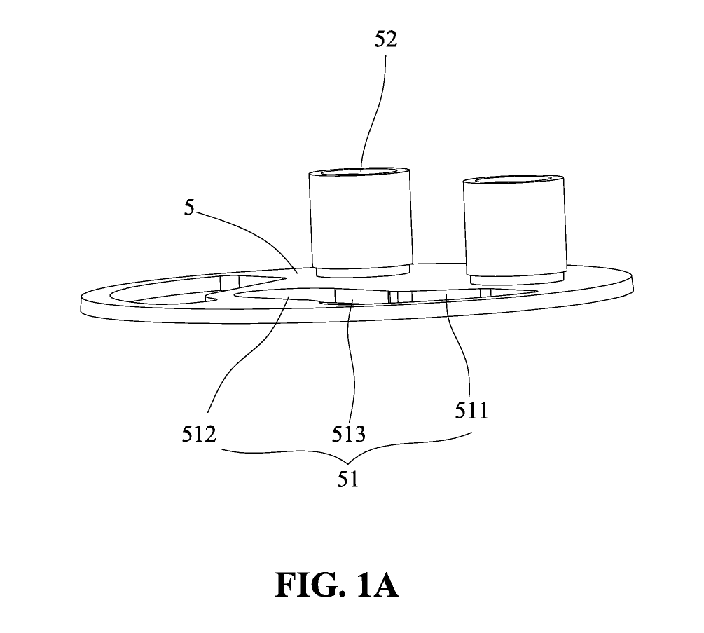

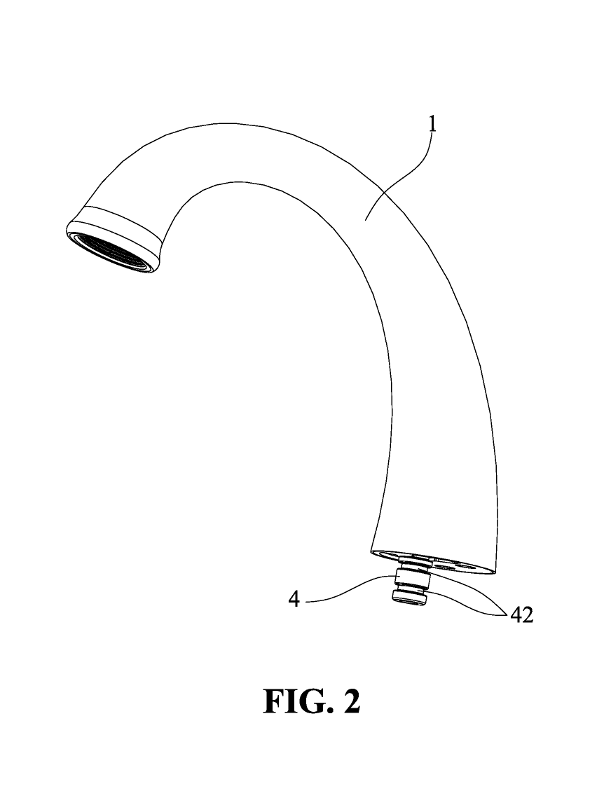

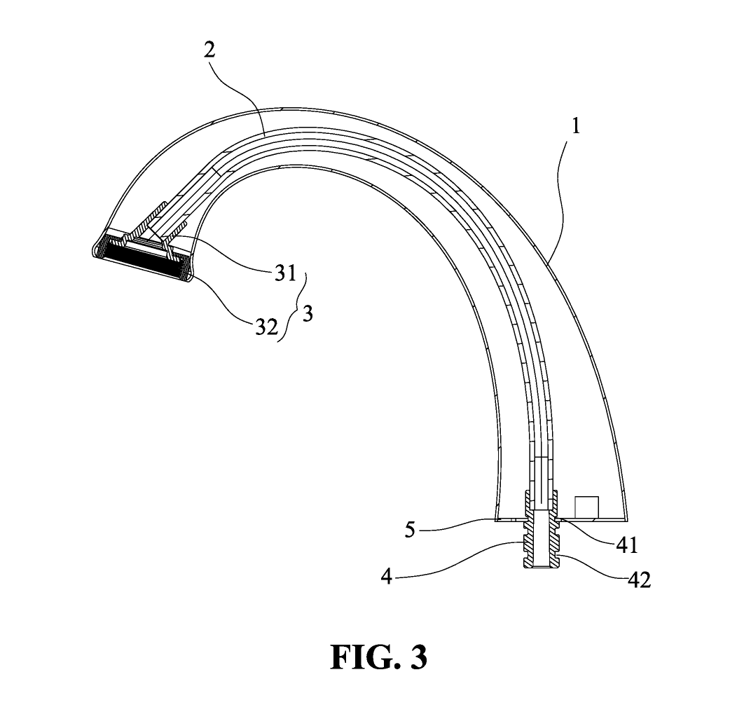

As shown in FIG. 1 to FIG. 3, the present invention discloses a water pipe structure of a basin faucet. The water pipe structure comprises an outer decorative pipe 1 made of a metal material and a soft pipe 2 made of a plastic material. The soft pipe 2 is mounted in the outer decorative pipe 1. One end of the soft pipe 2 is connected with a water outlet connector 3, and another end of the soft pipe 2 is connected with a water inlet connector 4. An outer circumference of the water outlet connector 3 is fixed to the outer decorative pipe 1. One end of the water inlet connector 4 is fixed to the soft pipe 2, and another end of the water inlet connector 4 extends out of the outer decorative pipe 1 and is sealedly connected with a water inlet pipe. One end of the outer decorative pipe 1, connected with the water inlet connector 4, is provided with a base 5. The outer wall of the water inlet connector 4 is tightly mated with the base 5.

The water outlet connector 3 includes a fixing sleeve 31 and a metal retaining ring 33. The fixing sleeve 31 is fixedly disposed at a water outlet end of the soft pipe 2. The outer wall of the fixing sleeve 32 is mated with the inner wall of the metal retaining ring 33. The outer wall of the metal retaining ring 33 is fixed to a water outlet end of the outer decorative pipe 1 by welding, screwing or snap-in. The water outlet connector 3 may be mounted with a faucet aerator.

The base 5 is fixed to the inner wall of a water inlet end of the outer decorative pipe 1. The base 5 has a through hole 51 and at least one mounting hole 52. The water inlet connector 4 has a neck 41 mated with the through hole 51. As shown in FIG. 1A, the through hole 51 includes a large hole 511 and a small hole 512. The large hole 511 is communicated with the small hole 512. The junction of the large hole 511 and the small hole 512 is formed with a reduced opening 513 less than the small hole 512. The large hole 511 has a diameter equal to or greater than the outer diameter of the water inlet connector 4. The small hole 512 has a diameter equal to that of the neck 41 of the water inlet connector 4. When the water inlet connector 4 is to be fitted into the through hole 51 of the base 5, it is first inserted into the large hole 511 to pass through the reduced opening 513 of the through hole 51, and then the neck 41 of the water inlet connector 4 is engaged with the small hole 512. One end of the water inlet connector 4, opposite to the soft pipe 2, is formed with at least one annular groove 42 (there are two annular grooves in the figure). Each annular groove 42 is provided with a sealing ring (not shown), so that the water inlet connector 4 is sealedly connected with the water inlet pipe. The mounting hole 52 cooperates with a locking screw to fix the basin faucet to a basin.

When assembled, the water inlet connector 4 and the fixing sleeve 31 of the water outlet connector 3 are fixed to both ends of the soft pipe 2, respectively. The metal mounting ring 32 and the base 5 are fixed to the water outlet end and the water inlet end of the outer decorative pipe 1, respectively. The soft pipe 2 connected with the water inlet connector 4 and the water outlet connector 3 is inserted from the water inlet end of the outer decorative pipe 1 to enter the outer decorative pipe 1 and extend out from the water outlet end of the outer decorative pipe 1. The fixing sleeve 31 on the soft pipe 2 is engaged with the metal mounting ring 32. The water inlet connector 4 on the soft pipe 2 is inserted into the large hole 511 of the base 5 to pass through the reduced opening 513 of the through hole 51, and then the neck 41 of the water inlet connector 4 is engaged with the small hole 512. For ease of assembly, the wall thickness of the outer decorative pipe 1 is uniform, which is convenient for the water inlet connector 4 to be inserted into the outer decorative pipe 1.

The water pipe structure of the basin faucet of the present invention adopts the outer decorative pipe 1 made of a metal material and the soft pipe 2 made of a plastic material and mounted in the outer decorative pipe 1. Under the premise of not affecting the quality of the basin, the water flows in the soft pipe 2, not in contact with the outer decorative pipe 1, and will not cause secondary pollution. The basin faucet provides non-toxic, harmless and green environment-friendly effects. In addition, the water inlet connector 4 and the water outlet connector 3 of the present invention are directly fixed to soft pipe, so that the connection is stable. The water inlet connector 4 extends out of the outer decorative pipe 1 so as to be connected to the water inlet pipe conveniently.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A water pipe structure of a basin faucet, comprising an outer decorative pipe made of a metal material and a soft pipe made of a plastic material, the soft pipe being mounted in the outer decorative pipe, one end of the soft pipe being fixed to a water outlet connector, another end of the soft pipe being fixed to a water inlet connector, an outer circumference of the water outlet connector being fixed to the outer decorative pipe, one end of the water inlet connector being fixed to the soft pipe, another end of the water inlet connector extending out of the outer decorative pipe and being sealedly connected with a water inlet pipe, one end of the outer decorative pipe, connected with the water inlet connector, being provided with a base, an outer wall of the water inlet connector being tightly mated with the base.

2. The water pipe structure of the basin faucet as claimed in claim 1, wherein the water outlet connector includes a fixing sleeve and a metal retaining ring, the fixing sleeve is fixedly disposed at a water outlet end of the soft pipe, an outer wall of the fixing sleeve is mated with an inner wall of the metal retaining ring, and an outer wall of the metal retaining ring is fixed to a water outlet end of the outer decorative pipe.

3. The water pipe structure of the basin faucet as claimed in claim 2, wherein the metal retaining ring is connected to the outer decorative pipe by welding, screwing or snap-in.

4. The water pipe structure of the basin faucet as claimed in claim 1, wherein the base is fixed to an inner wall of a water inlet end of the outer decorative pipe, the base has a through hole and at least one mounting hole, and the water inlet connector has a neck mated with the through hole so that the water inlet connector is connected to the through hole.

5. The water pipe structure of the basin faucet as claimed in claim 4, wherein the through hole includes a large hole and a small hole, the large hole is communicated with the small hole, the junction of the large hole and the small hole is formed with a reduced opening less than the small hole, the large hole has a diameter equal to or greater than an outer diameter of the water inlet connector, and the small hole has a diameter equal to that of the neck of the water inlet connector.

6. The water pipe structure of the basin faucet as claimed in claim 5, wherein one end of the water inlet connector, opposite to the soft pipe, is formed with at least one annular groove, and the annular groove is provided with a sealing ring.

7. The water pipe structure of the basin faucet as claimed in claim 1, wherein the outer decorative pipe is a curved pipe, and the curved pipe has a uniform wall thickness.
